(19) United States
(12) Patent Application Publication
(10) Pub. No.: US 2009/0124509 A1
(43) Pub. Date: May 14, 2009

(54) Protein-biochip for validating binding agents

(75) Inventors: Petra Weingarten, Dortmund (DE); Angelika Luking, Bochum (DE); Verena Trappe, Dortmund (DE)

Correspondence Address: CONNOLLY BOVE LODGE & HUTZ, LLP, P O BOX 2207, WILMINGTON, DE, 19899, US

(73) Assignee: Protagen AG, Dortmund (DE)

(21) Appl. No.: 11/791,562

(22) PCT Filed: Nov. 24, 2005
(86) PCT No.: PCT/EP05/12567

§ 371 Date: Jan. 9, 2008

(30) Foreign Application Priority Data
Nov. 24, 2004 (DE) 10 2004 056 794.8

(51) Int. Cl. C40B 30/04; C40B 40/10; C40B 40/08; C40B 40/18; C40B 40/04

(52) U.S. Cl. 506/9; 506/18; 506/17; 506/15; 506/22

(57) ABSTRACT

The invention relates to an arrangement of proteins containing at least one cDNA-expression library and to the use thereof as a protein-biochip, in particular for validating binding agents and protein binding agents and to a method for determining in a simultaneous manner quantitative variables.

The present invention relates to an array of proteins containing at least one expression library and its use as a protein biochip, especially for the validation of binders in the presence of protein binders, and methods for the simultaneous determination of quantitative variables.

Protein biochips are of increasing industrial importance regarding analysis and diagnostics, as well as for pharmaceutical development.

Particularly, a high gain of information could be provided using protein biochips in the analysis of the genome and of gene expression. Hereby, the fast and highly parallel detection of a multiplicity of specifically binding analysis molecules in the course of a single experiment is enabled. To generate protein biochips it is necessary that the required proteins are available. For this purpose, protein expression libraries were established. One possibility is high-throughput cloning of defined open reading frames (Heyman, J. A., Cornthwaite, J., Foncerrada, L., Gilmore, J. R., Gontang, E., Hartman, K. J., Hernandez, C. L., Hood, R., Hull, H. M., Lee, W. Y., Marcil, R., Marsh, E. J., Mudd, K. M., Patino, M. J., Purcell, T. J., Rowland, J. J., Sindici, M. L. and Hoeffler, J. P. (1999) Genome-scale cloning and expression of individual open reading frames using topoisomerase I-mediated ligation. Genome Res, 9, 383-392; Kersten, B., Feilner, T., Kramer, A., Wehrmeyer, S., Possling, A., Witt, I., Zanor, M. I., Stracke, R., Lueking, A., Kreutzberger, J., Lehrach, H. and Cahill, D. J. (2003) Generation of Arabidopsis protein chip for antibody and serum screening. Plant Molecular Biology, 52, 999-1010; Reboul, J., Vaglio, P., Rual, J. F., Lamesch, P., Martinez, M., Armstrong, C. M., Li, S., Jacotot, L., Bertin, N., Janky, R., Moore, T., Hudson, J. R., Jr., Hartley, J. L., Brasch, M. A., Vandenhaute, J., Boulton, S., Endress, G. A., Jenna, S., Chevet, E., Papasotiropoulos, V., Tolias, P. P., Ptacek, J., Snyder, M., Huang, R., Chance, M. R., Lee, H., Doucette-Stamm, L., Hill, D. E. and Vidal, M. (2003) C. elegans ORFeome version 1.1: experimental verification of the genome annotation and resource for proteome-scale protein expression. Nat Genet, 34, 35-41.; Walhout, A. J., Temple, G. F., Brasch, M. A., Hartley, J. L., Lorson, M. A., van den Heuvel, S. and Vidal, M. (2000) GATEWAY recombinational cloning: application to the cloning of large numbers of open reading frames or ORFeomes. Methods Enzymol, 328, 575-592). However, this approach highly depends on the progress of genome sequencing projects and the annotation of these gene sequences. Furthermore, the determination of the expressed sequence can be ambiguous due to differential splicing processes. This problem may be circumvented by application of cDNA expression libraries (Bussow, K., Cahill, D., Nieffeld, W., Bancroft, D., Scherzinger, E., Lehrach, H. and Walter, G. (1998) A method for global protein expression and antibody screening on high-density filters of an arrayed cDNA library. Nucleic Acids Research, 26, 5007-5008; Bussow, K., Nordhoff, E., Lubbert, C., Lehrach, H. and Walter, G. (2000) A human cDNA library for high-throughput protein expression screening. Genomics, 65, 1-8; Holz, C., Lueking, A., Bovekamp, L., Gutjahr, C., Bolotina, N., Lehrach, H. and Cahill, D. J. (2001) A human cDNA expression library in yeast enriched for open reading frames. Genome Res, 11, 1730-1735; Lueking, A., Holz, C., Gotthold, C., Lehrach, H. and Cahill, D. (2000) A system for dual protein expression in Pichia pastoris and Escherichia coli, Protein Expr. Purif., 20, 372-378). Hereby, the cDNA of a particular tissue is cloned into a bacterial or a yeast expression vector. The vectors used for the expression are characterized in general by carrying inducible promoters that may be used to control the time of protein expression. Furthermore, expression vectors comprise sequences for so-called affinity epitopes or proteins which permit the specific detection of recombinant fusion proteins using an antibody directed against the affinity epitope, as well as the specific purification through affinity chromatography (IMAC).

For example, the gene products of a cDNA expression library from human fetal brain tissue in the bacterial expression system Escherichia coli were arranged in a high-density format on a membrane, and could be screened successfully with various antibodies. It could be shown that there were at least 66% full length proteins. Additionally, the recombinant proteins of this library could be expressed and purified in high-throughput manner (Braun P., Hu, Y., Shen, B., Halleck, A., Koundinya, M., Harlow, E. and LaBaer, J. (2002) Proteome-scale purification of human proteins from bacteria. Proc Natl Acad Sci USA, 99, 2654-2659; Büssow (2000) supra; Lueking, A., Horn, M., Eickhoff, H., BÜssow, K., Lehrach, H. and Walter, G. (1999) Protein microarrays for gene expression and antibody screening. Analytical Biochemistry, 270,103-111). Particularly, such protein biochips based on cDNA expression libraries are a subject of WO 99/57311 and WO 99/57312.

In the art, such protein arrays based on cDNA expression libraries have been used predominantly for qualitative analysis. However, there is a strong need to use these protein biochips based on cDNA expression libraries for validation of binders on protein binders (e.g. antibody/antigen).

Particularly, (relative) quantitative variables are relevant for quality determination of a binder on a protein binder, such as, but not limited to, “cross reactivity”, “specificity” or “sensitivity”, “dynamic range”.

In the art, such (relative) quantitative variables are used individually and sequentially rather than in parallel or concomitantly, and are measured preferably using conventional methods such as e.g. dot blot, Western blot, ELISA, EIA or RIA. Recently, protein arrays and protein biochips have been used as well. For example, the binding specificity of various monoclonal antibodies such as anti HSP90, anti GAPDH or anti a-tubulin, could be analyzed in individual experiments on a protein microarray consisting of 96 human recombinantly expressed proteins (Lueking (1999) supra). Also, cross-reactivity of two monoclonal antibodies against approximately 2,500 different proteins could be studied (Lueking, A., Possling, A., Huber, O., Beveridge, A., Horn, M., Eickhoff, H., Schuchardt, J., Lehrach, H. and Cahill, D. J. (2003) A Nonredundant Human Protein Chip for Antibody Screening and Serum Profiling. Mol Cell Proteomics, 2, 1342-1349).

Therefore, the invention relates to a protein microarray in order to be able to determine at least two or more quantitative variables in parallel or concomitantly or simultaneously.

This object is solved by providing an array of protein binders, containing at least one cDNA expression library, where a first content region of the array represents a totality of protein binders, optionally together with binders, wherein in a second content region of the array at least one protein binder selected from the totality of protein binders is represented in one or more different quantities relative to the first content region.

The term “protein binder” according to the present invention means that a binder contacts a protein binder, with the protein binder being present, or binds to, or at least interacts with, a protein binder. In the broadest sense, the binder is directed to the protein binder, or the binder recognizes the protein binder, or the protein binder has the potential to interact with a binder.

Protein binders may be proteins, peptides, modified proteins/peptides, recombinant proteins/peptides, antibodies or antigens, or other proteins that may be represented on a protein biochip according to the invention. Ideally, the protein binders are obtained from the cDNA expression library, and are immobilized accordingly. Furthermore, the protein binders may be chemically or physically modified, e.g., but not limited to, biotinylation, phosphorylation, heat denaturation or denaturation using 4-8 molar urea, mercaptoethanol treatment to reduce sulfide bridges.

Suitable binders according to the present invention may be, but not limited to: proteins, peptides, modified proteins/peptides, recombinant proteins/peptides, antibodies or antigens, or other proteins, proteids, hormones, non-proteins such as e.g. RNA, DNA or aptamers, chemical probes, chemical molecules, particularly low molecular weight substances, organic or inorganic substances, substance libraries, ligands, pharmaceuticals, etc.

The binders may be present in purified form or mixed, or even in a heterogeneous protein mixture, such as a lysate or digest (e.g. bacterial lysate, mammal cell lysate). This reflects the quality of the binder in complex mixtures, such as for example present in immunohistochemistry.

In a further embodiment of the invention, the binder is also present (e.g. immobilized) in the totality of the protein binders (first region of the array according to the invention). Particularly advantageously, the quantification of specific signals as well as cross-reacting signals may be conducted. This allows for a direct comparison between the protein binders. Particularly, an internal standard is possible.

The invention especially relates to a protein binder array in which the first content and the second content form a unit, wherein this unit is accessible for at least one binder. Especially, this unit is a physical and spatial unit. One possible embodiment is shown in FIG. 1 (content=region).

The embodiments according to the invention may be particularly advantageous for determination of relative quantitative variables, such as “cross-reactivity” and “sensitivity” as well as the “dynamic range” of the binder or protein binder.

In the meaning according to this invention, “cross-reactivity” refers to the property of the protein binders to bind, or at least interact with, not only real binders but also with heterologous similar structures (e.g. other similar binders). For the quality of a protein binder, a low cross-reactivity is crucial. In other words, the more uniquely a binder recognizes a protein binder or is addressed to a protein binder, the more specific or valuable the binder is. For example, an antigen epitope is crucial for successful binding to an antibody. Different antibodies may exhibit different binding success to an antigenic epitope. This is crucial for the corresponding cross reactivity.

Thus, the “levels” of cross-reactivity and specificity are closely related to each other. Binders showing a high degree of cross-reactivity are classified as unspecific. Furthermore, the specificity of a binder may also be determined by the ability of the binders to recognize and/or differentiate isoforms or processed forms (such as phosphorylation) of protein binders

The sensitivity of a binder in the meaning of this invention describes the minimally required concentration of the protein binder that may be still detected with this binder (see FIG. 2a).

The “dynamic range” in the meaning of this invention describes the range between the highest and the lowest detection values (signal intensity) between binder/protein binder, wherein mostly a linear relationship exists between signal intensity and concentration of the detected protein binder. Thus, the dynamic range, plotted as signal intensities vs. quantities per unit, describes the correlation of the binder binding to the protein binder (see FIG. 2a).

Thus, such an array of protein binders also relates to a diagnostic or a protein biochip or protein microarray. Within the context of this invention, “arrangement” is a synonym for “array”, and provided that this “array” is used to identify binders or protein binders, it is meant to be an “assay”. In a preferred embodiment, the array is designed in such way that the protein binders represented on the array are present in the form of a grid. Furthermore, such arrays are preferred that enable a high-density array of protein binders. Such high-density arrays are for example disclosed in WO 99/57311 and WO 99/57312.

In a particular embodiment, the protein binders are present as clones, especially in the first region of the array according to the invention. For example, such clones may be obtained by using a cDNA expression library according to the invention (Bussow et al. 1998 (supra)). In a preferred embodiment, such expression libraries containing clones are obtained using expression vectors from a cDNA expression library. These expression vectors preferably contain inducible promoters. Induction of the expression may be obtained e.g. using an inductor such as IPTG. Suitable expressions vectors are described in Terpe et al. (Terpe T. Appl Microbiol Biotechnol. 2003 January; 60(5):523-33). Additionally, the expression product is present preferably in the form of a fusion protein which contains for example at least one affinity epitope or tag. The tag may be one, but not limited to, containing c-myc, his tag, arg tag, FLAG, alkaline phosphatase, VS tag, T7 tag or strep tag, HAT tag, NusA, S tag, SBP tag, thioredoxin, DsbA, a fusion protein, preferably a cellulose-binding domain, green fluorescent protein, maltose-binding protein, calmodulin-binding protein, glutathione S-transferase or lacZ.

Expression libraries are known to an expert in the art; they may be prepared according to standard text books such as Sambrook et al, “Molecular Cloning, A laboratory handbook, 2nd edition (1989), CSH press, Cold Spring Harbor, N.Y. Also preferred are tissue-specific expression libraries (e.g. human tissue, especially human organs). Furthermore included according to the invention are expression libraries that can be obtained by exon-trapping. A synonym for expression library is expression bank.

Also preferred are protein biochips or corresponding expression libraries that do not exhibit any redundancy (so called: Uniclone® library) and that may be prepared for example according to the teachings of WO 99/57311 and WO 99/57312. These preferred Uniclone libraries have a high portion of non-defective fully expressed proteins of a cDNA expression library.

Within the context of this invention, the clones could also be, but not limited to, transformed bacteria, recombinant phages or transformed cells from mammals, insects, fungi, yeast or plants.

The clones or protein binders are fixed or immobilized on a solid support.

The term “solid support” comprises designs such as a filter, a membrane, a magnetic bead, a silica wafer, glass, metal, ceramics, plastics, a chip, a target for mass spectrometry or a matrix.

Said solid support may be chemically coated. For this, silylation, polylysine, epoxydation or other common coatings known to the expert may be especially considered.

As a filter, PVDF or nylon are preferred (e.g. Hybond N+ Amersham), whereas nitrocellulose (e.g. Schleicher & Schuell) is especially preferred. Said filter is preferably mounted on a second solid support which is preferably selected from silica wafer, glass, metal, plastics or ceramics.

Furthermore it is preferred that the solid support is planar and flat.

In another preferred embodiment of the array according to the invention, the array corresponds to a grid with the dimensions of a microtiter plate (96 wells, 384 wells or more), a silica wafer, a chip, a target for mass spectrometry, or a matrix.

According to the invention, such an array according to the invention may enable screening of at least one binder to the protein binders with subsequent interpretation.

After the binder has contacted a protein binder, interpretation is conducted, for example using commercially available image analyzing software (GenePix Pro (Axon Laboratories), Aida (Ray test), ScanArray (Packard Bioscience).

For interpretation, the signal intensities are plotted versus the concentrations in order to determine sensitivity and the dynamic range.

To determine cross-reactivity, the signal intensities of the specific protein binders (e.g. antigens) to which the binders are directed, is set to 100%. The signal intensities of the cross-reacting protein binders are correlated hereto and used to evaluate the binder.

Therefore, the array according to the invention allows for the simultaneous or concomitant determination of relative quantitative variables.

This is particularly due to the fact that the array allows for a sample individualization of the binder for the first and second content region of the array according to the invention. The first and second content regions are accessible for a sample containing at least one binder. This results in a favorably high sample reproducibility and standardization and high-throughput application of this array according to the invention.

Visualization of said binders may be performed for example using fluorescence labeling, biotinylation or radioisotope labeling in the usual way. Readout may be conducted e.g. using a microarray laser scanner.

A “totality of protein binders” in the meaning of the invention means, that a sufficient number of different protein binders and optionally binders may be used. Preferred are at least 96 to 25,000 (numerically) or more out of various protein binders. However, preferred are more than 2,500, particularly preferred 10,000 or more protein binders, that are derived from an expression library. These protein binders may be present preferably in an amount of 1 amole to 10 pmole per spot, area unit or volume unit, particularly preferred 1-100 fmole.

The term “one or more different quantities” means that e.g. different concentrations (weigh/area unit, weight/volume unit, mole (particle number)/area unit, mole (particle number)/volume unit) may be present. Specifically, a so-called linear concentration series or a linear dilution series may be present. Preferred series are from 1 μmole to 0.1 amole, particularly 100 pmole to 0.1 fmole, especially preferred 10 pmole to 1 fmole on one area unit or volume unit or per spot (e.g. of a microarray). According to the invention it is crucial that at least one “protein binder” from the “totality of protein binders” is present in different quantities in the first compared to the second content region. Furthermore it is preferred that one or more protein binders selected from the “totality of protein binders” are present in the second content region in a linear concentration series or in a linear dilution series.

In a further preferred embodiment “totality of protein binders” comprises control proteins. These control proteins serve to determine a standard, and are preferably distributed homogeneously throughout the “totality of protein binders” in the first content region and/or the second content region. The known signal of said control protein may be put in relation to the measured signals. The preferably homogeneous distribution of the control protein allows for a qualitative validation of the results throughout the entire first and/or second content region.

Furthermore the protein binder array according to the invention allows for the simultaneous/concomitant validation of several binders or their comparative analysis with respect to relative quantitative variables.

Therefore, the invention relates to a method or the use of an array according to the invention, wherein the unit comprising the first and second content regions is contacted with at least one binder. The invention further relates to a method or the use of an array according to the invention to compare one or more binders on protein binders, wherein a protein binder array according to the invention is contacted with the binders to be compared, and interpreted. The interpretation allows for the simultaneous (concomitant) determination of said relative quantitative variables.

For evaluation of the quality (validation) of the protein binder, the signal intensity of a specific binder, to which the binders are directed, is set to 100%. This may also be performed by using a control protein according to the invention. A correlation is established to the signal intensities of the cross-reacting binder/protein binders, which is then used to evaluate the one or more binders.

TABLE 1
Cross-reactivity study. Using three binders (A, S, C) as an
example, the different cross-reactivity is demonstrated.

| binder | % cross-reactivity | % signal vs. background |
|---|---|---|
| A | 3.1 | 0.7; 1.02; 6.2 |
| B | 0 | 0 |
| S | 3.1 | 58; 119; 144.6 |

For example, the analysis of three different binders (see FIG. 2b) vs. one protein binder (e.g. antigen) shows various levels of cross-reactivity. Binders A and C each show cross-reactivity with three more proteins (corresponding to 3.1% total cross-reactivity), whereas binder B does not exhibit any cross-reactivity. In a second step one might want to determine the potency (in %) of the cross-reactive proteins compared to the specifically reacting antigen. For this, the signal intensity of the specific antigens is set to 100% (binder A: signal intensity of 62,000; binder C: signal intensity of 900), and the signal intensities of the cross-reacting proteins are put in correlation to this value. For binder A, cross-reactive signals of 0.7% (signal intensity of 435), 1.02% (631) and 6.2% (3858) are obtained. For binder C, cross-reactive signals of 58 % (signal intensity of 523), 119 % (1077) and 144 % (1301) are obtained (see table 1).

The following examples are meant to further discuss the invention without intending to limit the invention to these examples.

### EXAMPLES

Procedure: Generation of Proteins for Content 2 Field:

Expression clones from a cDNA expression library (Büssow (1998) supra) are grown in a high throughput format (96 well microtiter plate) over night. On the next day, protein expression of the clones is induced, followed by protein purification in a high throughput format. This process is entirely described in the following publications: (Büssow (2000) supra, Lueking (1999) supra, Lueking (2003) supra). The quality of the purified proteins is evaluated by SDS-PAGE.

If proteins of the Content 1 field are also derived from a cDNA expression library as described by Büssow et al., 1998 (supra), they could be expressed and purified in an analogous way. Otherwise, the proteins may also have a different origin (e.g. they may be commercially available).

Generation of the “Binder Validation Chip”:

First a suitable support is selected. A suitable support may be differently coated microscopic slides which are available from different commercial providers (e.g. Schleicher & Schull, Menzel, Sigma etc.). Two- as well as three-dimensional surfaces are well suited.

Then, the concentrations of the specific antigens/proteins are determined and correlated to the molarity in order to indicate “x” pmole/μL per antigen. Based on this figure, the specific antigens/proteins are diluted to defined concentrations (starting from high to low in the range of 10 pmole/μL to 1 fmole/μl).

The proteins of Content 1 and 1 and their dilutions are disposed in a 384 well microtiter plate, and are transferred to the selected surface using a standard spotting robot (such as the one being used for the preparation of DNA chips) (e.g. described in Lueking 2003 (supra)).

Thereafter, the loaded protein biochips are ready for the intended incubations.

Incubation:

For visualization, fluorescently labeled secondary antibodies against the binder are used, or the binder is already fluorescently labeled

The usual steps are described in Lueking et al. 1999 (supra), Lueking et al. 2003 (supra), the specific incubation conditions (blocking buffer, wash buffer, secondary antibody, incubation times) are determined as usual by the binder.

Visualization:

Using commercially available microarray laser scanners (ScanArray 4000 (Packard Bioscience)).

Image Analysis:

Using commercially available image analysis software GenePix Pro (Axon Laboratories), Aida (Raytest), ScanArray (Packard Bioscience).

Interpretation:

The interpretation is done e.g. using Excel (Microsoft), plotting signal intensities versus concentration to determine sensitivity and dynamic range.

In order to determine cross-reactivity, the signal intensity of the specific antigens against which the binders are directed, is set to 100%. The signal intensities of the cross-reacting antigens/proteins are correlated hereto, and are used to evaluate the binder.

Epitope Differentiation using Protein Biochips/An Antibody Validation Chip

The interpretation regarding cross reactivity shows that discrimination of antibodies with respect to their binding epitopes is possible.

Experiment: Analysis of the cross reactivity of three antibodies, A, B and C, directed to the same antigen (alpha 1 anti-trypsin), on a protein biochip with 2,500 clones (FIG. 1).

Analysis of the cross-reacting antigen shows that two antibodies (antibody A and C) bind identical antigens (antigens 1, 2, 3, 4, 5 and 8), whereas the third antibody (antibody A) reacts with other antigens (antigens 6 and 7) (see Table 1). This shows that antibodies B and C have the same binding epitope, whereas antibody A has a different epitope.

TABLE 1
Cross-reaction profile of the three alpha
1 anti-trypsin antibodies A, B and C:

| Antigen | Antibody A | Antibody B | Antibody C |
|---|---|---|---|
| Target antigen | 100% | 100% | 100% |
| Antigen 1 | No signal | 10% | 43% |
| Antigen 2 | No signal | 10% | 96% |
| Antigen 3 | No signal | 7% | 82% |
| Antigen 4 | No signal | 7% | 50% |
| Antigen 5 | No signal | 9% | 77% |
| Antigen 6 | 39% | No signal | No signal |
| Antigen 7 | 13% | No signal | No signal |
| Antigen 8 | No signal | 8% | 149% |

Differentiation of antibodies with respect to their epitopes enables fast selection of antibody pairs, for example to develop sandwich ELISAs, with one antibody serving as a capture antibody, whereas the second antibody would be used to detect the bound proteins/antigens.

### DESCRIPTION OF THE FIGURES

FIG. 1: Illustration of the binder validation chip. This protein biochip has two content regions. In the first content region (Content 1) the protein binders to be analyzed are immobilized in specific concentrations. The second content region (Content 2) includes a plurality of different protein binders which may be used to comparatively determine the level of cross-reactivity.

FIG. 2a: Determination of the sensitivity and the dynamic range. If the signal intensities are plotted versus the concentration of a protein binder, the resulting curve may indicate the dynamic range. The lowest measurable signal intensity (vs. background noise) determines the minimal measurable concentration and therefore the binder sensitivity.

FIG. 2b: Exemplary determination of the sensitivity and the dynamic range of three binders directed against an antigen. Here, the signal intensities of three different binders are plotted versus the concentration of a protein binder. Different dynamic ranges and binding behaviors for the three binders can be determined.

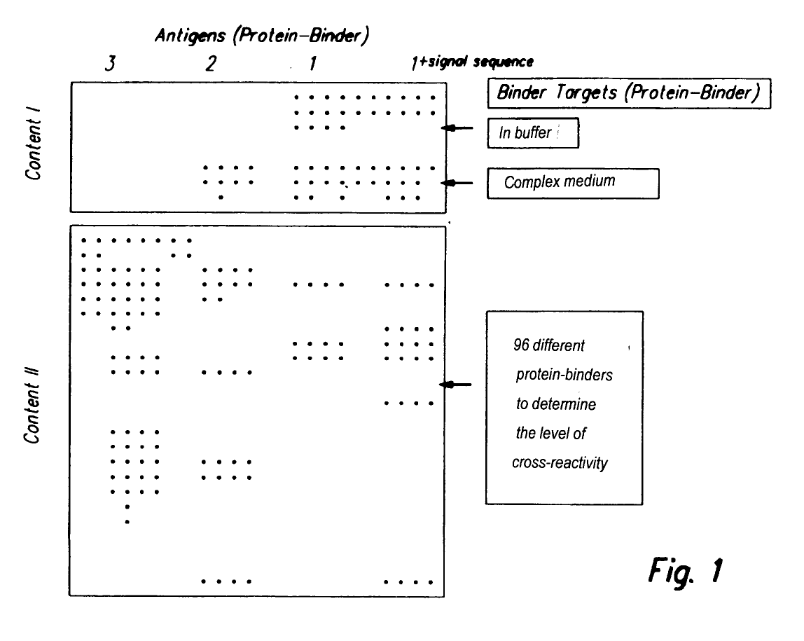

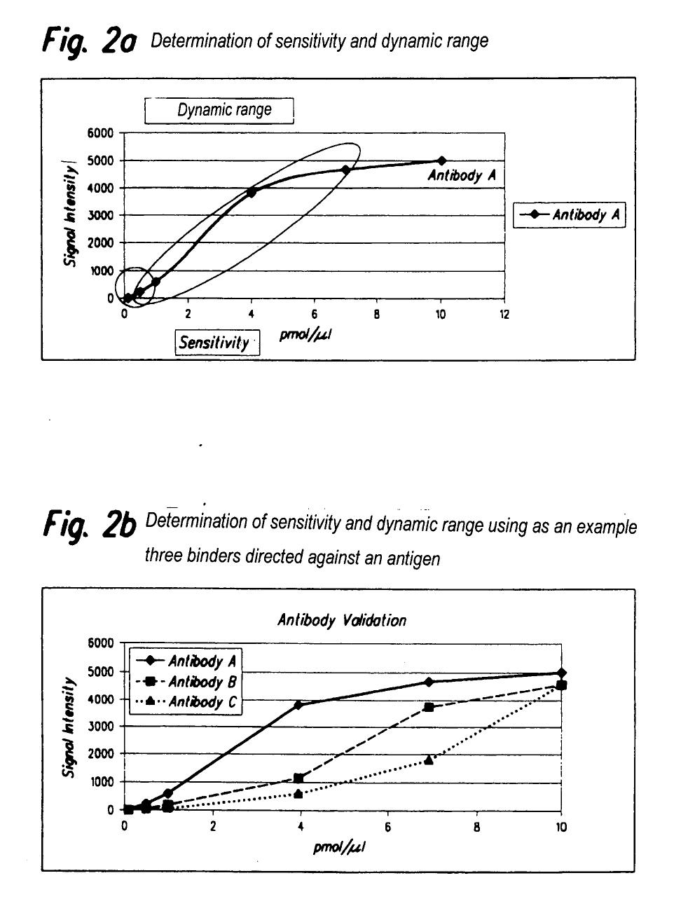

1. An array of protein binders including at least one cDNA expression library, wherein a first content region of the array represents a totality of protein binders, wherein in a second content region of the array at least one protein binder selected from the totality of protein binders is represented in one or more different quantities relative to the first content region.

2. An array of protein binders according to claim 1, characterized by the binder being represented in the totality of protein binders as well.

3. An array of protein binders according to claim 1, characterized by the first content region and the second content region forming a unit.

4. An array according to claim 3, characterized by the unit being accessible for at least one binder.

5. An array according to claim 1, characterized by the first and/or second content region containing at least one control protein.

6. An array according to claim 1, characterized by the first content region containing a totality of at least 96 to 25,000 or more protein binders being arranged in the form of a grid, and particularly having the dimensions of a microtiter plate, a silica wafer, a chip, a target for mass spectrometry or a matrix.

7. An array according to claim 1, characterized by the protein binders being immobilized or fixed on a solid support.

8. An array according to claim 7, characterized by the solid support being a filter, a membrane, a magnetic bead, a silica wafer, glass, metal, ceramics, plastics, a chip, a target for mass spectrometry or a matrix.

9. An array according to claim 7, characterized by the solid support being chemically coated, particularly using silylation, polylysine, epoxydation.

10. An array according to claim 7, characterized by the solid support being a filter, specifically consisting of PVDF, nylon or nitrocellulose, specifically being applied to a silica wafer, glass, metal, plastics or ceramics.

11. An array according to claim 7, characterized by the solid support being planar and flat.

12. An array according to claim 1, characterized by the protein binders being selected from proteins, peptides, modified proteins/peptides, recombinant proteins/peptides, antibodies or antigens.

13. An array according to claim 1, characterized by the protein binders being modified chemically or physically.

14. An array according to claim 1, characterized by the protein binders being clones from a cDNA expression library, particularly transformed bacteria, recombinant phages or transformed cells from mammals, insects, fungi, yeast or plants.

15. An array according to claim 14, characterized by the cDNA expression library being tissue-specific.

16. An array according to claim 14, characterized by the cDNA expression library being obtained using expression vectors from an expression library.

17. An array according to claim 16, characterized by the expression vectors containing inducible promoters.

18. An array according to claim 1, characterized by the protein binders being present as fusion proteins containing an affinity epitope or a tag.

19. An array according to claim 1, characterized by the different quantities in the second content region of the array being present in form of a linear concentration series or a linear dilution series.

20. An array according to claim 1, characterized by the array serving for the concomitant or simultaneous determination of relative qualitative variables of the binders or protein binders.

21. An array according to claim 20, characterized by the relative qualitative variables being cross-reactivity or specificity and sensitivity as well as the dynamic range.

22. An array according to claim 1, characterized by the binder being selected from the group consisting of proteins, peptides, modified proteins/peptides, recombinant proteins/peptides, antibodies or antigens, proteids, hormones, RNA, DNA or aptamers, chemical probes, and chemical molecules.

23. An array according to claim 1, characterized by the binders being present in purified form, and mixed or in a heterogeneous protein mixture, such as a lysate or a digest.

24. A protein biochip or protein microarray comprising an array of protein binders including at least one cDNA expression library, wherein a first content region of the array represents a totality of protein binders, wherein in a second content region of the array at least one protein binder selected from the totality of protein binders is represented in one or more different quantities relative to the first content region.

25. A method for comparison of two or more binders on protein binders, wherein an array according to claim 1 is contacting with the binders to be compared with the protein binders.

26. The array according to claim 18, characterized by the epitope or tag being selected from the group consisting of c-myc, his tag, arg tag, FLAG, alkaline phosphatase, V5 tag, T7 tag or strep tag, HAT tag, NusA, S tag, SBP tag, thioredoxin, DsbA, a fusion protein, a cellulose-binding domain, green fluorescent protein, maltose-binding protein, calmodulin-binding protein, glutathione S-transferase and lacZ.

27. The array according to claim 22, characterized by the chemical molecule being selected from the group consisting of low molecular substances, organic or inorganic substances, substance libraries, ligands, and pharmaceuticals.
